(19) United States
(12) Patent Application Publication
(10) Pub. No.: US 2013/0191526 A1
(43) Pub. Date: Jul. 25, 2013

(54) OPEN PLUG-IN MANAGEMENT PLATFORM AND PLUG-IN MANAGEMENT METHOD IMPLEMENTED ON BROWSER

(71) Applicant: Feng Zhao, Shenzhen (CN)

(72) Inventor: Feng Zhao, Shenzhen (CN)

(73) Assignee: TENCENT TECHNOLOGY SHENZHEN COMPANY LIMITED, Shenzhen Guangdong, CN (unknown)

(21) Appl. No.: 13/878,414

(22) PCT Filed: Feb. 24, 2012
(86) PCT No.: PCT/CN12/71602

§ 371 Date: Apr. 8, 2013

(30) Foreign Application Priority Data
Mar. 14, 2011 (CN) 201110060859.8

(51) Int. Cl. H04L 12/24

(52) U.S. Cl. CPC H04L 41/50
USPC 709/223

(57) ABSTRACT

The disclosure provides an open plug-in management platform implemented on a browser, the plug-in management platform is implemented during the host process of the browser, and is configured to act as an interacting medium of a plug-in with the browser, to control the interaction of a loaded plug-in with the browser, to manage the plug-in, and then to adapt the plug-in for invoking by the browser. The disclosure further provides an open plug-in management method implemented on a browser, including: a plug-in management platform implemented during the host process of the browser acts as a medium for interaction of a plug-in with the browser, controls the interaction of the loaded to plug-in with the browser, manages the plug-in, and then adapts the plug-in for invoking by the browser. With the platform and the method of the disclosure, various service or service application plug-ins can be managed, facilitating a user to use various service or service application functions implemented by an IT with the aid of a browser, and saving network bandwidth and network traffic.

### TECHNICAL FIELD

The disclosure relates to plug-in management techniques, in particular to an open plug-in management platform and a plug-in management method implemented on an intelligent terminal browser.

### BACKGROUND

An intelligent terminal (IT) is a blanket term for a type of user equipment (UE) which has an intelligent operating system and may be installed with a program provided by a third-party service provider and may provide various functions via such a program. For example, various currently popular Smartphone terminals are based on different intelligent operating systems, such as the currently popular Android platform, which is capable of installing at will various programs provided by a third-party service provider as with a computer. A browser refers to a Web or WAP (Wireless Application Protocol) is client side browsing program. The IT may send various requests to a Web or WAP server via the browser, and may interpret, show, and play various multimedia data formats and hypertext information sent from the Web or WAP server. A plug-in refers to a program wrote according to an application program interface of user service or service application standards. After the installation of the plug-in, the browser can process a service or service application corresponding to the plug-in by directly invoking the plug-in.

Currently, the IT is increasingly popularized, and requirements increase as well for a user to go online using the IT and the browser. As the browser processes a service or service application corresponding to a plug-in by directly invoking the plug-in when going online, meanwhile there are many kinds and a large number of various service or service application plug-ins, such that a lot of time is spent on a specific management such as identification, loading, updating, security authentication, and the like when the browser directly interacts with the plug-in, and occupation of a large amount of online time means the waste of network bandwidth and network traffic; therefore, there is a pressing need for a solution for plug-in management implemented on an IT browser to manage a plug-in efficiently and then adapt the plug-in for invoking by the browser, so as s to save network bandwidth and network traffic. Such a technical solution, however, is currently not available.

### SUMMARY

Accordingly, the main objective of the disclosure is to provide an open plug-in management platform and plug-in management method implemented on a browser capable of managing various service or service application plug-ins, facilitating a user to use various service or service application functions implemented by an IT with the aid of a browser, and saving network bandwidth and network traffic.

To this end, the technical solution of the present disclosure is implemented as follows.

The disclosure provides an open plug-in management platform implemented on a is browser, the plug-in management platform is implemented during the host process of the browser, and the plug-in management platform is configured to act as an interacting medium of a plug-in with the browser, to control the interaction of a loaded plug-in with the browser, to manage the plug-in, and then to adapt the plug-in for invoking by the browser.

The plug-in management platform may include; a plug-in engine, a plug-in behaviour managing unit, a plug-in adapting unit, a service unit, an event and message processing unit, and a plug-in interface, wherein

the plug-in engine may be an interface for interaction between the plug-in management platform and the browser;

the plug-in behaviour managing unit may be configured to manage various specific behaviours of the plug-in;

the plug-in adapting unit may be configured to convert bi-directionally a format of an event and a message interacted between the browser and the plug-in when the browser interacts with the plug-in with the help of the plug-in management platform;

the service unit may be configured to enable the plug-in to directly use a User Interface (UI) service and a network service provided by the browser via the service unit;

the event and message processing unit may be configured to process uniformly the event and the message, wherein the format of the event and the message has been processed by the plug-in adapting unit, wherein the processing may include: event and message distributing, event and message packaging, and providing to a corresponding functional application of event scheduling, registration managing, and message broadcasting; and

the plug-in interface may be an interface for interaction between the plug-in management platform and the plug-in.

The various specific behaviours may include: plug-in identifying, plug-in loading/unloading, plug-in version managing, plug-in security authenticating, plug-in upgrading installation, or plug-in capability managing.

The uniform processing may include: event and message distributing, event and message packaging, and providing to a corresponding functional application of event scheduling, registration managing, and message broadcasting.

The service unit may include: a plug-in UI service module and a network service module, wherein

the plug-in UI service module may be configured to enable the plug-in to directly use a UI service provided by the browser and promptly construct a UI required by the plug-in; and

the network service module may be configured to enable the plug-in to directly use a network service provided by the browser and promptly run a network running environment required by the plug-in.

The plug-in behaviour managing unit may include: an identifying module, a loading/unloading module, a version managing module, a security authenticating module, an upgrading installation module, and a capability managing module, wherein

the identifying module may be configured to automatically identify a plug-in requesting to be loaded;

the loading/unloading module may be configured to automatically load or unload the plug-in;

the version managing module may be configured to manage a plug-in version and compare plug-in version information stored locally by the browser with plug-in version information of the plug-in requesting to be loaded;

the security authenticating module may be configured to perform security authentication of the plug-in;

the upgrading installation module y be configured to perform upgrading installation of the plug-in, and

the capability managing module may be configured to manage the plug-in capability, which includes plug-in network capability and plug-in UI capability.

An open plug-in management method implemented on a browser, including: a plug-in management platform implemented during the host process of the browser acts as a medium for interaction of a plug-in with the browser, controls the interaction of the loaded plug-in with the browser, manages the plug-in, and adapts the plug-in for invoking by the browser,

The operation of managing, by the plug-in management platform, the plug-in may include: the plug-in management platform identifies an installed plug-in automatically, and loads the plug-in automatically after a plug-in loading condition is triggered and the plug-in passes a security authentication by the plug-in management platform.

The operation of managing, by the plug-in management platform, the plug-in may further include: the browser inquiries whether plug-in version information needs to be updated via the plug-in management platform when the browser is launched; stores the updated version information locally; when the browser acquires a plug-in loading request via the plug-in management platform, the browser compares the plug-in version information of the plug-in to be loaded with the plug-in version information stored in the local browser via the plug-in management platform and performs security authentication; and the browser loads, the plug-in automatically via the plug-in management platform after the plug-in passes security authentication.

The operation of managing, by the plug-in management platform, the plug-in may further include: an exit request is sent via the plug-in management platform and the plug-in is unloaded when the plug-in needs to exit.

The plug-in management platform of the disclosure is implemented during the host process of the browser, and is configured to act as an interacting medium of a plug-in with the browser, to control the interaction of a loaded plug-in with the browser, to manage the plug-in, and to adapt the plug-in for invoking by the browser.

With the present disclosure, instead of invoking the plug-in directly, the browser interacts with the plug-in through the plug-in management platform, and the plug-in management platform implements a specific managing behaviour such as identifying, loading, updating, and the like, manages the plug-in effectively, and adapts the plug-in for invoking by the browser, without the necessity to occupy significant online time, thus saving network bandwidth and network traffic.

### BRIEF DESCRIPTION OF THE DRAWINGS

FIG. 1 is a schematic view of the relation of a browser with a plug-in management platform and a plug-in according to the disclosure;

FIG. 2 is a schematic view of the structure of a plug-in management platform according to embodiment 1 of the disclosure; and

FIG. 3 is a flowchart for implementing a plug-in management method according to embodiment 2 of the disclosure.

### DETAILED DESCRIPTION

The basic idea of the disclosure is that: the plug-in management platform is implemented during the host process of the browser, and the plug-in management platform is configured to act as an interacting medium of a plug-in with the browser, to control the interaction of a loaded plug-in with the browser, to manage the plug-in, and then to adapt the plug-in for invoking by the browser. The preferred field of application of the disclosure is that the browser of a mobile terminal manages a plug-in via a plug-in managing platform instead of interacting with the plug-in using directly the browser, which can save traffic and accelerate the browsing speed of the browser.

The implementation of the technical solution is further elaborated with reference to the figures.

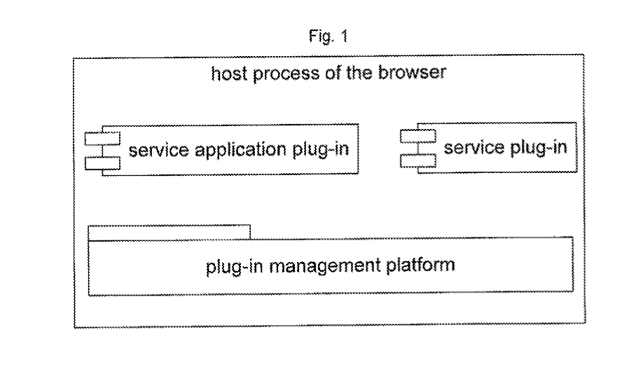

An open plug-in management platform implemented on a browser is as shown in FIG. 1, the plug-in management platform is implemented during the host process of the browser, acts as an interacting medium of a plug-in with the browser, controls the interaction of a loaded plug-in with the browser, manages the plug-in, and then adapts the plug-in for invoking by the browser. The plug-in management platform may be considered as a platform to provide a series of managements for the plug-in, such as identifying, security authenticating, version managing, loading/unloading, upgrading installation, and the like.

The plug-in may also be called a browser plug-in, the type of which includes a service plug-in and a service application plug-in. The service plug-in is configured to provide a service for the browser, for example a storage service, a network service, etc., and is without any interface, nor is it a specific product or service, and the user normally do not interact with a service plug-in directly. The client of the service plug-in is the browser and a service plug-in. The service application plug-in refers to a specific product plug-in, such as QQ and QQ music, etc., and interacts with the user directly. The client of the service plug-in is the user. What is to be noted here is that the “plug-in” herein, if not explicitly referred to as a service application plug-in or a service plug-in, in general stands for the service application plug-in and the service plug-in, includes both types of plug-ins, and is not further elaborated.

Here, a management function realized using the plug-in management platform includes that: for the scenario of a loaded application, interaction with various service application plug-ins and service plug-ins loaded is performed via the plug-in management platform implemented during the host process of the browser; an installed plug-in is identified automatically by the plug-in management platform, and is loaded automatically after a plug-in loading condition is triggered and the plug-in passes the security authentication by the plug-in management platform, thereby conveniently realizing a specific management function such as identification, loading, security authentication, and the like, thus the function and service of the browser can be conveniently expanded and enhanced through invoking of a plug-in by the browser.

Here, the plug-in management platform mainly includes: a plug-in engine, a plug-in behaviour managing unit, a plug-in adapting unit, a service unit, an event and message processing unit, and a plug-in interface. Each unit of the plug-in management platform is elaborated below.

The plug-in engine is an interface for interaction between the plug-in management platform and the browser.

The plug-in behaviour managing unit is configured to manage various specific behaviours of the plug-in. Various specific behaviours include: plug-in identifying, loading/unloading, plug-in version managing, plug-in security authenticating, plug-in upgrading installation, plug-in capability managing, and the like.

The plug-in adapting unit is configured to convert bi-directionally a format of an event and a message interacted between the browser and the plug-in when the browser interacts with the plug-in with the help of the plug-in management platform to create a running environment for the plug-in to run in the browser.

The service unit is configured to enable the plug-in to directly use a User Interface (UI) service and a network service provided by the browser via the service unit. The UI service aims at the entire service design for human-computer interaction, operation logic, and interface outlook for a software. As the UI service provided by the browser can be used directly, a UI required by the plug-in can be constructed promptly, making the user interface of the software personalized and tasty, as well as making the operation of the software comfortable, simple, and at ease. For the network service, as a network service provided by the browser can be used directly without the need to consider an underlying application (namely, factors such as specific network management, network signal strength, and the like), the network running environment required by the plug-in can be run promptly, saving network bandwidth and network traffic.

The event and message processing unit is configured to process uniformly the event and the message, wherein the format of the event and the message has been processed by the plug-in adapting unit. The processing includes event and message distributing, event and message packaging, and providing to a corresponding functional application of event scheduling, registration managing, and message broadcasting.

The plug-in interface is an interface for interaction between the plug-in management platform and the plug-in.

What needs to be noted is that, for the aforementioned function implemented in each unit of the plug-in management platform, multiple functions of one unit may be implemented with one functional module, or may be implemented respectively with a corresponding specific functional module, the advantage of which lies in that a function is separated and individually packaged and operated, and if the plug-in is to use a function, it uses directly the corresponding specific functional module, which can increase the efficiency, and helps to store data according to the category as well as to fetch the data.

For example, the plug-in behaviour managing unit may be divided into multiple specific functional module: an identifying module configured to automatically identify a plug-in; a loading/unloading module configured to automatically load and unload the plug-in; a message factory module configured to facilitate construction of various message methods; a version managing module configured to manage a plug-in version; a security authenticating module configured to perform security authentication of the plug-in; an upgrading installation module configured to perform upgrading installation of the plug-in; and a capability managing module configured to manage the plug-in capability, wherein the capability managing module mainly includes the management of plug-in network capability and plug-in UI capability.

An open plug-in management method implemented on a browser, mainly includes:

a plug-in management platform implemented during the host process of the browser acts as a medium for interaction of a plug-in with the browser, controls the interaction of the loaded plug-in with the browser, manages the plug-in, and then adapts the plug-in for invoking by the browser.

Here, the management of the plug-in includes that: the plug-in management platform identifies an installed plug-in automatically, and loads the plug-in automatically after a plug-in loading condition is triggered and the plug-in passes a security authentication by the plug-in management platform.

Here, the management of the plug-in may further include: the browser inquires whether plug-in version information needs to be updated via the plug-in management platform when the browser is launched, and stores the updated version information locally; and when the browser acquires a plug-in loading request via the plug-in management platform, the browser compares the plug-in version information of the plug-in to be loaded with the local plug-in version information and performs security authentication via the plug-in management platform, and loads the plug-in automatically via the plug-in management platform after the plug-in passes security authentication; the plug-in sends an exit request via the plug-in management platform and unloads the plug-in when the plug-in needs to exit.

To sum up, the open plug-in management platform and method based on an IT browser according to the disclosure not only reserves the advantages of an existing browser such as good universality, standard specification, strong model adapting capability, and the like, but also can develop rapidly multiple service and service application plug-ins through implementation of plug-in management by virtue of the plug-in management platform, so as to gain advantages such as better user experience (such as UI design), more economical network traffic, higher security, stronger functional expansibility, and the like. It is extremely valuable to be able to save traffic with limited bandwidth and resources of mobile internet, and high security protection is vital for guarantee of user privacy and user mobile payment provided.

Embodiment 1: an example of application of the plug-in management platform, wherein each functional unit in the plug-in management platform is divided into multiple specific functional modules.

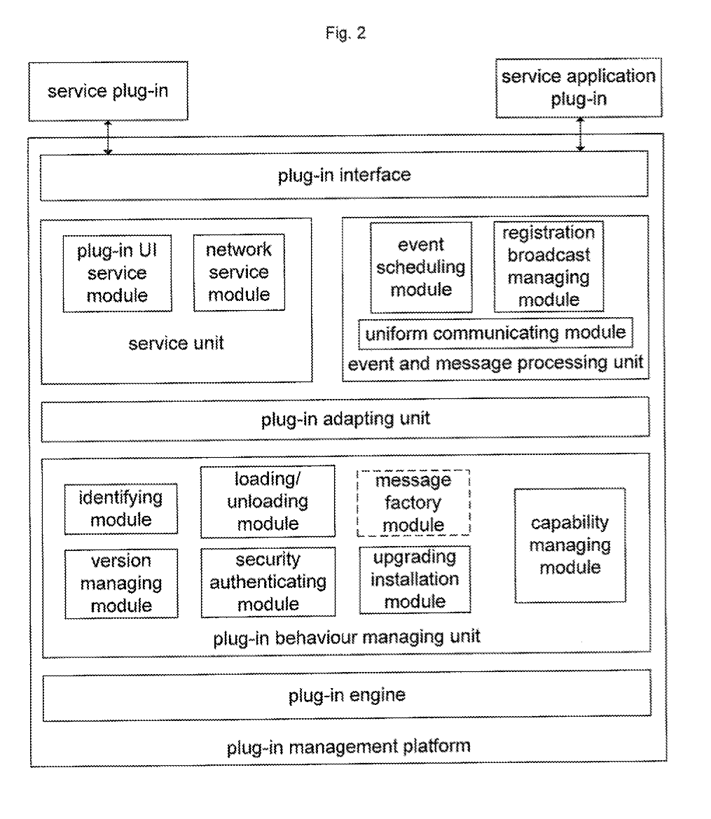

As shown in FIG. 2, the plug-in management platform of this embodiment includes a plug-in engine, a plug-in behaviour managing unit, a plug-in adapting unit, a service unit, an event and message processing unit, and a plug-in interface. The plug-in behaviour managing unit includes an identifying module, a loading/unloading module, a version managing module, a security authenticating module, an upgrading installation module, and a capability managing module. The service unit includes a plug-in UI service module and a network service module. The event and message processing unit includes an event scheduling module, a registration broadcast managing module, and a uniform communicating module. Each specific functional module in FIG. 2 is described below.

For the service unit, a plug-in (including two types of plug-ins, namely, the service plug-in and the service application plug-in) can access the service unit via a plug-in interface, the service unit provides a plug-in UI service and a network service based on the browser for the plug-in directly, respectively implemented via the plug-in UI service module and the network service module. The plug-in can directly use the UI service provided based on the browser via the plug-in UI service module, and construct promptly the UI required by the plug-in. Meanwhile, the plug-in can directly use the network service provided based on the browser via the network service module, and accesses the network service easily, without the need to consider an underlying application issue such as network management and mobile network signal, etc.

For the plug-in interface, the plug-in needs to derive and implement the plug-in interface, so as to be supported by the plug-in management platform. The plug-in accesses the service unit via the plug-in interface, to use directly the service provided based on the browser, such as the UI service and the network service, etc. By accessing only the service unit to directly use the service provided by the browser, module/service unit reuse can be increased considerably, reducing development time of each plug-in. The plug-in can also look up the available services that are provided by the service unit so as to have excellent backward compatibility. Each plug-in communicates and interacts with the browser via the plug-in interface to achieve an open and uniform processing flow. The backward compatibility, also known as downward compatibility, is a performance requirement based on a component standard and is the newest standard specification; a backward compatible component not only should meet the performance requirement of the category to which it belongs, but also should meet all performance requirements below its category. For example, the USB 2.0 standard is backward compatible for the lower version USB 1.1 standard.

The event and message processing unit uniformly processes the event and the message, wherein the format of the event and the message has been processed by the plug-in adapting unit, and can provide the event and message to the corresponding application function of event scheduling, message broadcasting, and registration managing via an event interface, a notifying/broadcasting interface, a registration interface, and the like. When produced, a message or event will be distributed or broadcast by the plug-in management platform to a corresponding plug-in. The uniform communicating module is the master program module for interaction of the plug-in with the browser, and implements Inter-Process Communication (IPC) between extended applications and an open and uniform processing flow of events and messages when the plug-in and the browser interact. The uniform communicating module adopts all uniform communicating interfaces, which provide an automatic data packaging format and method, so as to increase interface extensibility and universality. Moreover, the uniform communicating module also provides a communication buffer mechanism, to handle simultaneous communication requests heavily generated, increasing stability and reliability of the communication system.

The plug-in adapting unit provides an interface adapting service between the plug-in and the browser, and mainly functions to convert bi-directionally the format of an event and a message between the browser and the plug-in and the like.

The identifying module automatically identifies installed plug-in.

The loading/unloading module is in charge of loading or unloading a specified plug-in. The management in unloading includes: the unloading module will automatically unload a plug-in when the plug-in is no longer used and meets the unloading condition, wherein two unloading modes are provided, namely, synchronous and asynchronous unloading. The synchronous unloading means instant unloading; and the asynchronous unloading means sending an unloading request to the plug-in management platform which determines to reclaim and unload the plug-in under a certain subsequent circumstance.

For the version managing module, the plug-in and the browser are independently upgraded and developed respectively, the version compatibility is determined intelligently through the version managing module. The management in implementing version managing includes: case 1. prompting to install a plug-in if it is not installed yet; case 2. prompting the user to upgrade a plug-in when a lower version compatible plug-in has been installed; case 3. forcing to upgrade when a lower version incompatible plug-in has been installed.

The upgrading installation module provides an easy upgrading installation service based on the version management, wherein the plug-in can be updated easily into the newest version via the installation Application Program Interface (API) provided by the plug-in management platform.

The security authenticating module identifies a safe plug-in through techniques such as ID authentication, key verification, and the like, to exclude the loading of and replacement by a malicious plug-in, ensuring user security.

For the capability managing module, the plug-in is divided into many types of plug-ins, such as a system service plug-in, an application service plug-in, a UI type plug-in, a window type plug-in, and the like, and the browser will provide different services and supports for different plug-ins, therefore, the capability managing module for plug-in capability is in charge of maintaining plug-in capability status, which mainly includes the capability status of the UI and the network.

What needs to be noted here is that, from the point of view of cross-platform design, in order to render good extensibility and portability of the plug-in development, each IT platform can adopt the same architecture in implementing the plug-in management platform. At this point, in order to meet the cross-platform requirement, that is, to adopt the same architecture, it is required to ensure consistency in the following design indices.

Index a1: module division and hierarchical design of the plug-in management platform should be strictly consistent.

Index a2: the data, protocol, and command definition inside the plug-in management platform should remain completely consistent.

Index a3: the plug-in interface design should be compatible for respective characteristics of each platform, such as the UI interface and the event interface, so as to lower the plug-in development threshold of each platform.

Index a4: the other platform-irrelevant interfaces are designed consistently on the basis of the index a3, to ensure a maximal possibility of plug-in design consistency.

Index a5: the plug-in adapting layer of each platform requires very good design which can meet a seamless transition and connection of the plug-in management platform interface and the plug-in interface very well. Since plug-in management of each platform is implemented uniformly, while a plug-in interface may be different respectively, the adapting layer, that is, the plug-in adapting unit is required to do bi-directional conversion with high conversion efficiency, good reliability, and high compatibility.

What needs to be noted here is that, from an extensible and compatible design point of view, it is required to ensure implementation of the following design indices,

Index b1: good background control and synchronization mechanism to ensure compatibility between the version of the browser and the plug-in. The good compatibility of the entire system is ensured by way of recommended upgrading, forced upgrading, and the like.

Index b2: all service interfaces, event interfaces, and communicating interfaces adopt well extensible design.

Specifically, for the index b2,
i) the service interface is defined via a COM-like (Component Object Model, COM) interface, and the plug-in can complete a logic operation and ensure compatibility by looking up the available system services currently provided.
ii) both the plug-in and the plug-in management platform provide an extending and inquiring interface to complete compatibility authentication, for example, provide version inquisition, capability inquisition, and security authentication, and perform interaction and communication on this basis.
iii) good extensibility and compatibility is ensured by designing a uniform automatic communicating and serialized module, such that it does not require modification of any existing program to add or delete a command or data structure, with automatic forward and backward compatibility,
iv) good extensibility is ensured by designing and reserving a universal interface at each interface.
v) the issue of upgrading and conflict between plug-ins is solved flawlessly by each communication and command through centralized management of communication IDs and dynamic allocation of command words.

Index b3. The server side can also complete a management such as upgrading, enabling, disabling, or the like, of a plug-in by configuring the plug-in information.

Index b4. The server side can also achieve the function of extension by configuring and pushing a plug-in installing or upgrading package

What needs to be noted here is that, from a plug-in developing point of view, there are mainly three ways for plug-in development, namely,
1) adaption of an existing ordinary plug-in into a browser universal plug-in. The developer just needs to inherit the plug-in interface and realize a number of necessary interface implementations such as a version inquiring interface, a security authenticating interface, and a communicating interface. The browser needs to learn about information including security, and type and version of the plug-in via these interfaces, and provide corresponding management and support.
2) adaption of a plug-in based on an existing client side application program.

addition to completing the operation stated in 1), the developer just needs to modify the type of the program, namely, from app to dll.
3) a brand new development of a browser plug-in. The developer first creates a dll type project, implements the plug-in interface, and adds the necessary interface implementation, as well as logic control, UI design required by the plug-in, and the like.

A plug-in can be adapted or developed promptly, as universality and portability are considered in design of the plug-in management platform and a compatible plug-in interface is designed on various different IT platforms.

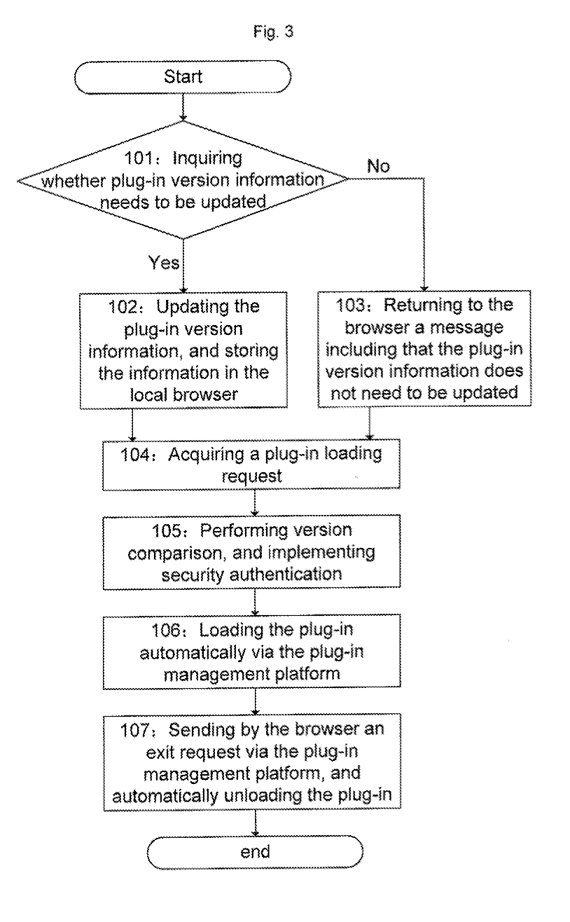

Embodiment 2: an example of plug-in usage flow, wherein a management function such as identifying, version comparing, security authenticating, loading and unloading, and the like is implemented by virtue of the plug-in management platform. As shown in FIG. 3, the flow includes the following steps:

Step 101: the browser inquires whether plug-in version information needs to be updated via the plug-in management platform when the browser is launched, and Step 102 is executed if so, otherwise Step 103 is executed,

wherein a specific inquiring operation may be implemented by the version managing module in the plug-in behaviour managing unit when the operation is implemented via the plug-in management platform in this step;

Step 102: the plug-in version information is updated, and the updated version information is synchronously stored in the local browser;

Step 103: returning to the browser a message including that the plug-in version information does not need to be updated;

Step 104: the browser acquires a plug-in loading request via the plug-in management platform;

Step 105: when the browser acquires the plug-in loading request via the plug-in management platform, the browser compares the plug-in version information of the plug-in to be loaded with the plug-in version information stored in the local browser via the plug-in management platform, and performs security authentication,

wherein the operation of implementing the specific security authentication in this step may be implemented by the security authenticating module in the plug-in behaviour managing unit;

Step 106: the browser loads the plug-in automatically via the plug-in management platform after the plug-in passes the security authentication; and

Step 107: an exit request (which may be expressed as an ECMDExit command) is sent via the plug-in interface of plug-in management platform when the plug-in needs to exit, wherein the plug-in management platform will automatically unload the plug-in by way of synchronous or asynchronous unloading according to the current quoting situation.

What described above are merely the preferred embodiments of the disclosure and are not intended to limit the scope of the disclosure.

1. An open plug-in management platform implemented on a browser, the plug-in management platform being implemented during the host process of the browser, and the plug-in management platform being configured to act as an interacting medium of a plug-in with the browser, to control the interaction of a loaded plug-in with the browser, to manage the plug-in, and to adapt the plug-in for invoking by the browser.

2. The open plug-in management platform according to claim 1, wherein the plug-in management platform comprises: a plug-in engine, a plug-in behaviour managing unit, a plug-in adapting unit, a service unit, an event and message processing unit, and a plug-in interface, wherein
the plug-in engine is an interface for interaction between the plug-in management platform and the browser;
the plug-in behaviour managing unit is configured to manage various specific behaviours of the plug-in;
the plug-in adapting unit is configured to convert bi-directionally a format of an event and a message interacted between the browser and the plug-in when the browser interacts with the plug-in with the help of the plug-in management platform;
the service unit is configured to enable the plug-in to directly use a User Interface (UI) service and a network service provided by the browser via the service unit;
the event and message processing unit is configured to process uniformly the event and the message, wherein the format of the event and the message has been processed by the plug-in adapting unit; and
the plug-in interface an interface for interaction between the plug-in management platform and the plug-in.

3. The open plug-in management platform according to claim 2, wherein the various specific behaviours comprise: plug-in identifying, plug-in loading/unloading, plug-in version managing, plug-in security authenticating, plug-in upgrading installation, or plug-in capability managing.

4. The open plug-in management platform according to claim 2, wherein the uniform processing comprises: event and message distributing, event and message packaging, and providing to a corresponding functional application of event scheduling, registration managing, and message broadcasting.

5. The open plug-in management platform according to claim 1, wherein the service unit comprises: a plug-in UI service module and a network service module, wherein
the plug-in UI service module is configured to enable the plug-in to directly use a UI service provided by the browser and promptly construct a UI required by the plug-in; and
the network service module is configured to enable the plug-in to directly use a network service provided by the browser and promptly run a network running environment required by the plug-in.

6. The open plug-in management platform according to claim 1, wherein the plug-in behaviour managing unit comprises: an identifying module, a loading/unloading module, a version managing module, a security authenticating module, an upgrading installation module, and a capability managing module, wherein
the identifying module is configured to automatically identify a plug-in requesting to be loaded;
the loading/unloading module is configured to automatically load or unload the plug-in;
the version managing module is configured to manage a plug-in version and compare plug-in version information stored locally by the browser with plug-in version information of the plug-in requesting to be loaded;
the security authenticating module is configured to perform security authentication of the plug-in;
the upgrading installation module is configured to perform upgrading installation of the plug-in; and
the capability managing module is configured to manage the plug-in capability, which comprises plug-in network capability and plug-in UI capability.

7. An open plug-in management method implemented on a browser, comprising: acting, by a plug-in management platform implemented during the host process of the browser, as a medium for interaction of a plug-in with the browser; controlling, by the plug-in management platform, the interaction of a loaded plug-in with the browser; managing, by the plug-in management platform, the plug-in; and adapting, by the plug-in management platform, the plug-in for invoking by the browser.

8. The open plug-in management method according to claim 7, wherein managing, by the plug-in management platform, the plug-in comprises: identifying, by the plug-in management platform, an installed plug-in automatically; and loading the plug-in automatically after a plug-in loading condition is triggered and the plug-in passes a security authentication by the plug-in management platform.

9. The open plug-in management method according to claim 7, wherein managing, by the plug-in management platform, the plug-in further comprises:
inquiring, by the browser, whether plug-in version information needs to be updated via the plug-in management platform when the browser is launched;
storing, by the browser, the updated version information locally;
when the browser acquires a plug-in loading request via the plug-in management platform, comparing, by the browser, the plug-in version information of the plug-in to be loaded with the plug-in version information stored in the local browser via the plug-in management platform, and performing security authentication; and
loading, by the browser, the plug-in automatically via the plug-in management platform after the plug-in passes security authentication.

10. The open plug-in management method according to claim 9, wherein managing, by the plug-in management platform, the plug-in further comprises: sending an exit request via the plug-in management platform and unloading the plug-in when the plug-in needs to exit.

11. The open plug-in management platform according to claim 2, wherein the service unit comprises: a plug-in UI service module and a network service module, wherein
the plug-in UI service module is configured to enable the plug-in to directly use a UI service provided by the browser and promptly construct a UI required by the plug-in; and
the network service module is configured to enable the plug-in to directly use a network service provided by the browser and promptly run a network running environment required by the plug-in,

12. The open plug-in management platform according to claim 3, wherein the service unit comprises: a plug-in UI service module and a network service module, wherein
the plug-in UI service module is configured to enable the plug-in to directly use a UI service provided by the browser and promptly construct a UI required by the plug-in; and
the network service module is configured to enable the plug-in to directly use a network service provided by the browser and promptly run a network running environment required by the plug-in.

13. The open plug-in management platform according to claim 4, wherein the service unit comprises: a plug-in UI service module and a network service module, wherein
the plug-in UI service module is configured to enable the plug-in to directly use a UI service provided by the browser and promptly construct a UI required by the plug-in; and
the network service module is configured to enable the plug-in to directly use a network service provided by the browser and promptly run a network running environment required by the plug-in.

14. The open plug-in management platform according to claim 2, wherein the plug-in behaviour managing unit comprises: an identifying module, a loading/unloading module, a version managing module, a security authenticating module, an upgrading installation module, and a capability managing module, wherein
the identifying module is configured to automatically identify a plug-in requesting to be loaded;
the loading/unloading module is configured to automatically load or unload the plug-in;
the version managing module is configured to manage a plug-in version and compare plug-in version information stored locally by the browser with plug-in version information of the plug-in requesting to be loaded;
the security authenticating module is configured to perform security authentication of the plug-in;
the upgrading installation module is configured to perform upgrading installation of the plug-in; and
the capability managing module is configured to manage the plug-in capability, which comprises plug-in network capability and plug-in UI capability.

15. The open plug-in management platform according to claim 3, wherein the plug-in behaviour managing unit comprises: an identifying module, a loading/unloading module, a version managing module, a security authenticating module, an upgrading installation module, and a capability managing module, wherein the identifying module is configured to automatically identify a plug-in requesting to be loaded;
the loading/unloading module is configured to automatically load or unload the plug-in;
the version managing module is configured to manage a plug-in version and compare plug-in version information stored locally by the browser with plug-in version information of the plug-in requesting to be loaded;
the security authenticating module is configured to perform security authentication of the plug-in;
the upgrading installation module is configured to perform upgrading installation of the plug-in; and
the capability managing module is configured to manage the plug-in capability, which comprises plug-in network capability and plug-in UI capability.

16. The open plug-in management platform according to claim 4, wherein the plug-in behaviour managing unit comprises: an identifying module, a loading/unloading module, a version managing module, a security authenticating module, an upgrading installation module, and a capability managing module, wherein
the identifying module is configured to automatically identify a plug-in requesting to be loaded;
the loading/unloading module is configured to automatically load or unload the plug-in;
the version managing module is configured to manage a plug-in version and compare plug-in version information stored locally by the browser with plug-in version information of the plug-in requesting to be loaded;
the security authenticating module is configured to perform security authentication of the plug-in;
the upgrading installation module is configured to perform upgrading installation of the plug-in; and
the capability managing module is configured to manage the plug-in capability, which comprises plug-in network capability and plug-in UI capability.

17. The open plug-in management method according to claim 8, wherein managing, by the plug-in management platform, the plug-in further comprises:
inquiring, by the browser, whether plug-in version information needs to be updated via the plug-in management platform when the browser is launched;
storing, by the browser, the updated version information locally;
when the browser acquires a plug-in loading request via the plug-in management platform, comparing, by the browser, the plug-in version information of the plug-in to be loaded with the plug-in version information stored in the local browser via the plug-in management platform, and performing security authentication; and
loading, by the browser, the plug-in automatically via the plug-in management platform after the plug-in passes security authentication.

18. The open plug-in management method according to claim 17, wherein managing, by the plug-in management platform, the plug-in further comprises: sending an exit request via the plug-in management platform and unloading the plug-in when the plug-in needs to exit.
